(19) United States
(12) Patent Application Publication
(10) Pub. No.: US 2009/0167145 A1
(43) Pub. Date: Jul. 2, 2009

(54) PHOSPHOR ELECTROLUMINESCENT DEVICES

(75) Inventors: Rob Withnall, Middlesex (GB); Jack Silver, Middlesex (GB); George Fern, Oxford (GB); Peter Evans, Middlesex (GB); David Harrison, Middlesex (GB)

Correspondence Address: DARBY & DARBY P.C., P.O. BOX 770, Church Street Station, New York, NY, 10008-0770, US

(73) Assignee: Brunel University, Middlesex (GB)

(21) Appl. No.: 12/293,119

(22) PCT Filed: Mar. 16, 2007
(86) PCT No.: PCT/GB07/00950

§ 371 Date: Dec. 22, 2008

(30) Foreign Application Priority Data
Mar. 16, 2006 (GB) 0605369.8

(51) Int. Cl. H01J 1/62; H01J 9/00

(52) U.S. Cl. 313/494; 445/58

(57) ABSTRACT

There is disclosed an electroluminescent device (200; 300; 400; 500) in which a phosphor (6) is deposited in gaps (3) between electrodes (2a, 2b). The deposition of phosphor on top of the electrodes is minimised as phosphor on top of the centre of an electrode will not experience a significant electrical field and thus will not usefully emit light. Some embodiments improve the efficiency with which phosphor is utilised during manufacture. In some embodiments (400; 500) the electrodes and phosphor may be on opposite sides of a substrate (1). In some embodiments (100), the phosphor has a sufficiently high dielectric strength that a dielectric layer between the phosphor and the electrodes is not required.

The present invention relates to phosphor electroluminescent devices and in particular to devices which use a powder phosphor.

WO 99/55121 discloses an electroluminescent device in which a phosphor (that has been encapsulated between layers of a dielectric sandwich) is deposited over interdigitated electrodes. The phosphor and dielectric sandwich is deposited both on top of the electrodes and in the gaps between the electrodes.

An aim of some embodiments of the present invention is to provide an electroluminescent device in which a phosphor is selectively deposited so that the phosphor is substantially only deposited in inter-electrodes gaps between electrodes of the device.

According to the present invention, there is provided an electroluminescent device comprising:
a substrate;
one or more first electrodes on the substrate;
one or more second electrodes on the substrate; and
a phosphor deposited substantially only in inter-electrode gaps between the electrodes.

An advantage of the selective deposition of phosphor only in the gaps is that it is in the gap regions that the phosphor experiences the greatest electrical fields. In contrast, phosphor on top of the electrodes experiences a reduced or even zero electrical field due substantially only to fringing fields. Phosphor is expensive and thus prior art devices do not efficiently utilise the phosphor. Embodiments of the present invention provide a brightness comparable to prior art device whilst using a reduced quantity of phosphor.

Some embodiments of the present invention utilise a phosphor composition that includes a binder as disclosed in WO 02/090464. Such phosphors do not require a dielectric sandwich to encapsulate the phosphor to protect against electrical breakdown.

Electroluminescent devices are well-known but prior art devices generally require at least one of the electrodes to be transparent, in order to allow the light to pass through the transparent electrode. Such transparent electrodes are generally fabricated by coating a transparent substrate (e.g. glass or plastic) with a film of transparent conducting oxide (TCO) such as indium tin oxide (ITO). The transparent electrode is at the front of the device (front electrode) and the electroluminescent light is emitted from the device through the TCO electrode. The distance between the back electrode and the front TCO electrode is some tens of micrometres, thereby enabling electric fields on the order of 10⁴ V/cm to be generated between the electrodes when the necessary voltage is applied across the electrodes. A disadvantage of transparent electrodes such as TCO is that they are expensive and require toxic chemicals.

An aim of some embodiments of the present invention is to provide an electroluminescent device that does not require a transparent electrode.

Some embodiments of the present invention provide an electroluminescent device with conducting fine-line tracks as electrodes having widths of some tens of micrometres. These electrode tracks are interdigitated such that alternate electrode tracks have opposite polarity. The width of the gaps between the electrode tracks is also some tens of micrometres, thereby enabling electric fields on the order of 10⁴ V/cm to be generated between the alternate electrode tracks when the necessary voltage is applied across the electrodes.

The fine-line electrode tracks can be deposited on substrates by offset lithographic printing a conducting ink such as an ink containing small particles of a metal, such as silver, gold or copper. However, the fine-line electrode tracks can instead be deposited on a substrate by other printing methods such as contact printing, and inkjet printing. Alternatively, the electrode tracks may be deposited by methods other than printing, such as lamination. Another way in which electrode tracks can be formed on a substrate is by etching; for example the printed circuit board (PCB) industry manufactures PCBs by using a photographic process to form an etch resist on a copper sheet bonded to a substrate, the copper sheet is then etched to leave tracks on the substrate. A combination of these methods may be used.

The electrical conductivity of the tracks can be increased if desired by annealing the tracks, once deposited, using methods such as laser annealing. This annealing has the affect of increasing the contact between the metal particles. When using lasers for annealing the tracks, the laser beam will be focused onto the fine metal particles but not the substrate itself, so that the annealing will not modify the substrate.

The substrate may be formed a range of materials such as paper and/or different types of polymer. The substrate material should have a dielectric strength that is sufficient to withstand the electric fields necessary to excite the electroluminescent phosphor particles. When offset lithographic printing is used for deposition of the electrode tracks, the substrate is preferably flexible; however, the substrate can be rigid when using other methods of deposition of the electrode tracks, such as lamination. When printing the electrode tracks onto the substrate using offset lithographic printing, the devices can be mass produced at low cost.

A layer or layers of electroluminescent phosphor can be printed on top of the electrode tracks and gaps, either completely covering the track and gap structure or the phosphor layer(s) can be patterned to give an incomplete covering of the track and gap structure. Various methods can be used for printing the phosphor layers, such as screen printing, K-bar, doctor blading or other printing and deposition methods. The electroluminescent phosphor layer(s) can be prepared using ink vehicles that can contain binder(s) and dielectric(s) as well as electroluminescent phosphor particles.

By using different electroluminescent phosphors in the ink vehicles, multi-coloured displays can be mass produced. Furthermore dyes and other colour conversion materials can be incorporated into the ink vehicles, along with colour filters, to give a wider colour range.

### BRIEF DESCRIPTION OF THE DRAWINGS

FIG. 1a shows a plan view of a first embodiment of an electroluminescent device, comprising a phosphor layer which overlies interdigitated electrode tracks on a substrate.

FIG. 1b shows a cross-sectional view, in the plane II-II′ of FIG. 1a, of an enlarged portion of the electroluminescent device of FIG. 1.

FIG. 2 shows a cross-sectional view of a second embodiment of an electroluminescent device, in which phosphor is deposited only between electrodes.

FIG. 3 shows a cross-sectional view of a third embodiment of an electroluminescent device, comprising a protective layer above a phosphor layer.

FIG. 4 shows a cross-sectional view of a fourth embodiment of an electroluminescent device, comprising electrodes on a first side of a substrate and a phosphor layer on the other side of the substrate.

FIG. 5 shows a cross-sectional view of a fifth embodiment of an electroluminescent device, comprising electrodes on a first side of a substrate and comprising electrodes on a second side of the substrate.

### DESCRIPTION OF PREFERRED EMBODIMENTS

### First Embodiment

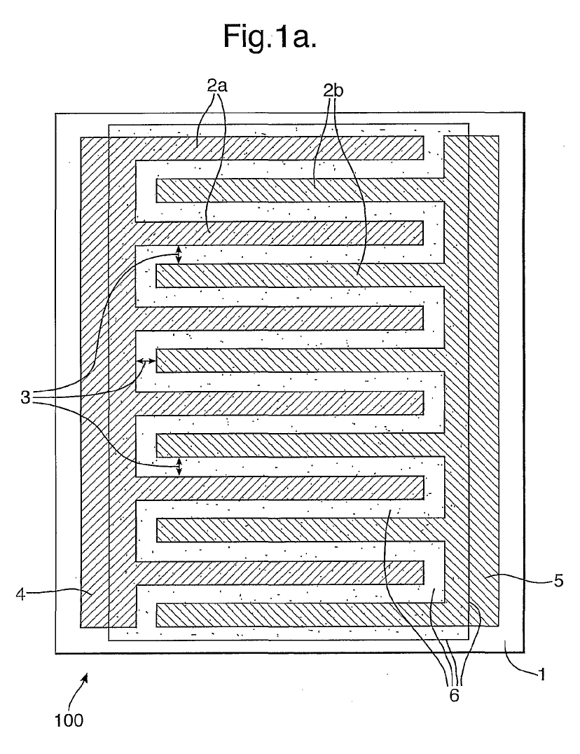

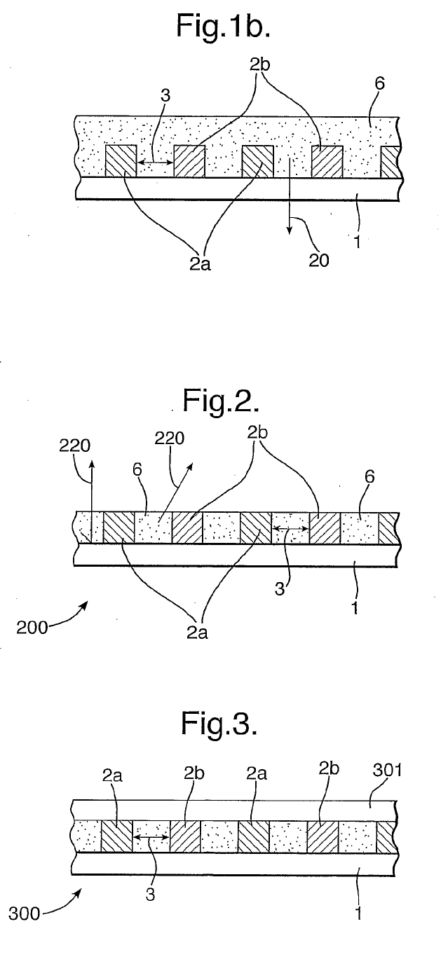

FIG. 1a shows a plan view of an electroluminescent device 100. As shown in FIG. 1a, the device 100 comprises a translucent substrate 1, on which electrically conducting electrode tracks 2a, 2b are formed. It can be seen from FIG. 1a that the electrode tracks 2a, 2b are interdigitated so that alternate electrode tracks have opposite polarity. The electrode tracks 2a, 2b are separated by gaps 3 across which a voltage is applied.

In this embodiment, electrode tracks 2a are connected in common to an electrical bus 4; electrode tracks 2b are connected in common to an electrical bus 5. In alternative embodiments, the configuration of the electrode tracks can be, for example, as complex or as simple as desired, and the width of the gaps 3 can be as small as, for example, 15 μm (micrometres) or less, allowing a diverse range of display architectures to be fabricated.

FIG. 1a shows a plurality of electrodes 2a and a plurality of electrodes 2b. Alternative embodiments may for example have a single electrode 2a interdigitated between two electrodes 2b or may have a single electrode 2a adjacent a single electrode 2b.

A layer of electroluminescent phosphor 6 can be printed directly on top of the electrodes. FIG. 1a shows a continuous layer of the electroluminescent phosphor 6 but, in alternative embodiments, patterns of phosphor can be printed on top of the electrodes 2a, 2b and the patterns can be as complex or as simple as desired.

FIG. 1b shows a cross-sectional view, in the plane II-II′ of FIG. 1a, of an enlarged portion of the electroluminescent device 100 of FIG. 1a. In this embodiment the tracks 2a, 2b have a width of 50 μm, a length of 2 cm and a height above the substrate 1 of 5 μm. The gaps 3 have a width of 50 μm. In this embodiment the phosphor 6 comprises particles (not shown) that have a size greater than 5 μm. In alternative embodiments, the phosphor 6 may comprise particles of phosphor that have a size less than 5 μm that infill the gaps 3 between the electrodes 2a, 2b. FIG. 1b also shows light 20 emitted from phosphor 6 that lies between the gaps 3.

As those skilled in the art will appreciate, the phosphor 6 may be excited using, for example, an AC voltage in the range 200 Hz (hertz) to 5 kHz having an amplitude of 100V (volts). The phosphor 6 may comprise zinc sulphide doped with copper and/or manganese. Alternatively, the phosphor 6 may comprise zinc gallate (ZnGa₂O₄) doped with manganese or may comprise CaTiO₃ doped with Pr. The phosphor 6 may comprise a binder. Examples of phosphors and binders are disclosed in WO 02/090464.

WO 02/090464 discloses a phosphor composition comprising a phosphor powder held in a binder comprising a mixture of two constituents, one constituent being one or more drying oils or semi drying oils or derivatives thereof and the other constituent being one or more sol-gel precursors. Such phosphor/binder compositions have a high dielectric strength which allows them to be placed in direct contact with the electrodes of an electroluminescent device, in other words without one or more intervening dielectric layers (which may be used to form a “sandwich”) to separate the phosphor from the electrodes. In some embodiments, the binder increases (compared to the phosphor on its own) the dielectric constant of the phosphor/binder composition which increases the electric field strength experienced by the phosphor and thus increases the brightness for a given excitation voltage.

FIGS. 1a and 1b show a translucent (or, preferably, transparent) substrate 1 through which light 20 can pass. In an alternative embodiment, an opaque substrate may be used and the light may instead be transmitted through the phosphor 6.

### Second Embodiment

FIG. 2 shows a cross-sectional view of an electroluminescent device 200. In the electroluminescent device 200, phosphor 6 is substantially only deposited in the gaps 3 on the substrate 1 between the electrodes 2a, 2b. Thus unlike the electroluminescent device 100, substantially no phosphor 6 lies on top of the electrodes 2a, 2b. In this embodiment the substrate 1 is reflective so that light emitted towards the substrate 1 is reflected and escape upwards as light 220. Of course, light 220 that is emitted upwards escapes the phosphor 6 without being reflected of the substrate 1.

An advantage of the electroluminescent device 200 is that less phosphor is required even though the brightness of the electroluminescent device 200 is substantially the same as the brightness of the electroluminescent device 100. This is because the strongest electrical field is in the gaps 3 directly between the electrodes 2a, 2b. Although phosphor 6 in other regions (i.e. not directly in the gaps 3) of the electroluminescent device 100 will also emit light, in these regions the phosphor 6 experience only a fringing field.

The electroluminescent device 200 may be manufactured by offset lithographically printing phosphor 6 substantially only into the gaps 3 between the electrodes 2a, 2b. Depending on the resolution and registration of the offset lithographic printer, the gaps 3 may have widths as small as 7, 25, 50 or 100 μm. Screen printing may be used instead of offset lithographic printing although screen printing generally has reduced resolution and registration compared to offset lithographic printing. Thus if screen printing is used then there is an increased possibility that some phosphor 6 will be inadvertently deposited on top of the electrodes 2a, 2b instead of only in the gaps 3.

An alternative method for manufacturing the electroluminescent device 200 is to deposit phosphor 6 onto the substrate 1 (such that phosphor 6 is not only deposited in the gaps 3 but also over the electrodes 2a, 2b) and then use a doctor blade or a squeegee blade (not shown) to wipe away the excess phosphor 6 on top of the electrodes 2a, 2b so that phosphor 6 remain substantially only in the gaps 3.

In other embodiments an inkjet printer (not shown) may be used to selectively deposit the phosphor 6 substantially only in the gaps 3 between the electrodes.

### Third Embodiment

FIG. 3 shows a cross-sectional view of an electroluminescent device 300, comprising a protective layer 301 above a phosphor layer 6.

In this embodiment the protective layer 301 is a translucent polyethylene film and encapsulates, between the substrate 1 and the protective layer 301, the phosphor 6. Light may pass through the protective layer 301. The protective layer 301 provides the advantage that the phosphor 6 is protected from moisture and oxidation. The protective layer 301 also provides the advantage of increasing the physical robustness of the phosphor 6. For example, the protective layer 301 makes it more difficult for children or infants to scrape away the phosphor 6 and thereby touch high voltages present on the electrodes 2a, 2b.

In other embodiments the protective layer 301 may be reflective, for example a metallised plastic. In such embodiments the protective layer 301 will also act to reflect light back towards the substrate 1 and, if the substrate 1 is translucent, through the substrate 1.

### Fourth Embodiment

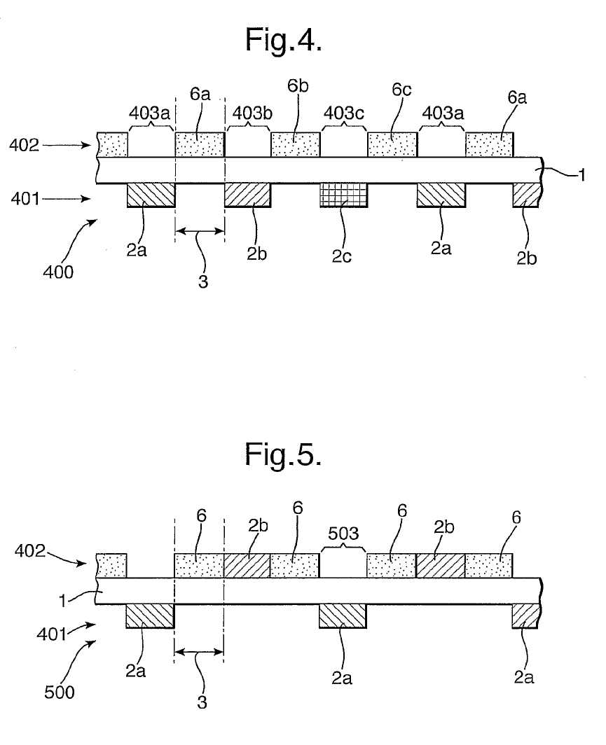

FIG. 4 shows a cross-sectional view of an electroluminescent device 400, comprising electrodes 2a, 2b, 2c on a first side 401 of the substrate 1 and a phosphor layer 6 (comprising phosphors 6a, 6b, 6c) on the other side 402 of the substrate 1.

In this embodiment, the phosphors 6a, 6b, 6c are located in the gaps 3 between the electrodes 2a, 2b, 2c. Unlike FIGS. 2 and 3, the electrodes are on a first side 401 of the substrate 1 whereas the phosphors 6a, 6b, 6c are on a second side 402 of the substrate 1. Like FIGS. 2 and 3, there is substantially no phosphor 6a, 6b, 6c at regions 403a, 403b, 403c above the electrodes 2a, 2b, 2c. Even though the phosphors 6a, 6b, 6c are not directly in between the electrodes 2a, 2b, 2c the phosphors 6a, 6b, 6c still experience an electrical field similar to FIGS. 2 and 3, provided that the substrate 1 is not excessively thick.

Although in FIG. 4 the phosphors 6a, 6b, 6c experience, strictly speaking, fringing electrical fields (and not a “direct” electrical field) between the electrodes 2a, 2b, 2c, provided that the substrate 1 is not of excessive thickness then the phosphors 6a, 6b, 6c experience an electrical field similar to the “direct” electrical field of FIGS. 2 and 3. Any slight reduction in brightness will in many applications be acceptable, especially given that the electroluminescent device 400 is amenable to more rapid manufacture than FIGS. 2 and 3; electrodes 2a, 2b, 2c may be printed onto side 401 simultaneously with the printing of phosphors 6a, 6b, 6c onto side 402, thus improving manufacturing throughput.

The phosphor 6 may be excited by applying a suitable AC voltage across electrodes 2a and 2b, across electrodes 2b and 2c, or across electrodes 2c and 2a. In this embodiment, three different phosphors 6a, 6b, 6c are interdigitated on the substrate 1. Electrodes 2a and 2b may be used to emit red light using phosphor 6a, electrodes 2b and 2c may be used to emit green light using phosphor 6b, and electrodes 2c and 2a may be used to emit blue light using phosphor 6c. In yet other embodiments, one or more of the phosphors may emit other colours or may emit light of a wavelength not visible to the human eye. In other embodiments, the phosphors 6b and 6c may be identical and the AC frequency used to excite the phosphors may be chosen to select green emission from the phosphor 6b and blue light from the phosphor 6c. In yet other embodiments, all the phosphors 6a, 6b, 6c may be used to emit blue light. The phosphor 6b may include a coating or an ingredient to downconvert the blue light to green light, and the phosphor 6c may include a coating or an ingredient to downconvert the blue light to red light.

Whereas FIG. 4 shows a substantially planar substrate 1, in alternative embodiments the substrate may be crenellated, having for example repeated square furrows. In such embodiments, the electrodes may be recessed in furrows on one side of the non-planar substrate and the phosphors may be recessed in furrows on the other side of the non-planar substrate. If the height of the crenellations is suitable, the phosphors 6a, 6b, 6c may be directly between the electrodes 2a, 2b, 2c while still being on the opposite side of the non-planar substrate.

### Fifth Embodiment

FIG. 5 shows a cross-sectional view of an electroluminescent device 500, comprising electrodes 2a on a first side 401 of a substrate 1 and comprising electrodes 2b on a second side 402 of the substrate. The electrodes 2a, 2b are interdigitated but are positioned on opposite sides of the substrate 1. A phosphor 6 is formed on the second side 402 of the substrate 1, substantially only in gaps 3 between the electrodes 2a, 2b. As shown, the phosphor 6 lies adjacent the electrodes 2b and touches the electrodes 2b. FIG. 5 shows that each electrode 2b is sandwiched laterally between two regions of phosphor 6; there is then a gap 503 (overlying each electrode 2a) until next phosphor-electrode-phosphor sandwich.

In alternative embodiments, the substrate 1 may be crenellated. For example, the phosphor 6 and electrodes 2b may be recessed in furrows on side 402 of the non-planar substrate and the electrodes 2a may be recessed in furrows on side 401 of the non-planar substrate.

FIG. 5 shows gaps 503 between the regions of phosphor 6. In alternative embodiments there are no gaps 503 and instead the phosphor 6 forms a continuous region between each pair of adjacent electrodes 2b. Such embodiments have the advantage that a dielectric layer is not required to separate the phosphor from the electrodes 2b.

### Other Embodiments

In alternative embodiments, a dielectric layer (not shown) may be interposed between the electrodes 2a, 2b and the phosphor 6. In other embodiments, two dielectric layers may be sued to “sandwich” the phosphor 6. Such dielectrics are typically used in electroluminescent devices to reduce dielectric breakdown of the phosphor.

In some embodiments a phosphor 6 is deposited in gaps 3 between electrodes 2a, 2b. The deposition of phosphor on top of the electrodes is minimised as phosphor on top of the centre of an electrode will not experience a significant electrical field and thus will not usefully emit light. Some embodiments improve the efficiency with which phosphor is utilised during manufacture. In some embodiments 400; 500 the electrodes and phosphor may be on opposite sides of a substrate 1. In some embodiments 100, the phosphor has a sufficiently high dielectric strength that a dielectric layer between the phosphor and the electrodes is not required to avoid electrical breakdown. Some embodiments may comprise a binder to increase the dielectric strength of the phosphor.

In embodiments that use particles of phosphor, small phosphor particles are in general preferred as small particles enable the gaps 3 between electrodes to be reduced and so allow the use of a reduced excitation voltage compared to larger gaps. As those skilled in the art will appreciate, the lifetime-brightness product of small phosphor particles is presently often less than that of larger particles as smaller particles tend to degrade more rapidly.

1. An electroluminescent device comprising:
a substrate;
one or more first electrodes on the substrate;
one or more second electrodes on the substrate;
one or more phosphor regions on the substrate, wherein the phosphor is substantially only present in one or more gaps between the electrodes.

2. The device according to claim 1, wherein the first and second electrodes are interdigitated.

3. The device according to claim 1, wherein the one or more first electrodes and the one or more second electrodes are on the same side of the substrate.

4. The device according to claim 1, wherein the one or more first electrodes and the one or more second electrodes are opaque.

5. The device according to claim 1, wherein the phosphor is on the same side of the substrate as the one or more first electrodes and the one or more second electrodes.

6. The device according to claim 1, wherein the substrate is reflective.

7. The device according to claim 1, wherein the substrate is translucent.

8. The device according to claim 1, wherein the phosphor comprises particles.

9. The device according to claim 8, wherein the phosphor comprises a binder comprising a first and second constituent, the first constituent being one or more drying oils or semi drying oils or derivatives thereof and the second constituent being one or more sol-gel precursors.

10. The device according to claim 9, wherein the phosphor is in direct contact, without an intervening dielectric layer, with the one or more first electrodes and the one or more second electrodes.

11. The device according to claim 1, comprising two or more different phosphors.

12. The device according to claim 1, comprising one or more third electrodes on the substrate.

13. The device according to claim 1, comprising a protective layer for protecting the phosphor.

14. The device according to claim 1, comprising an electrical bus for connecting two or more first electrodes and an electrical bus for connecting two or more second electrodes.

15. The device according to claim 1, wherein the substrate 1 is crenellated.

16. A method of manufacturing an electroluminescent device comprising the steps of:
forming electrodes on a substrate; and
forming a phosphor on the substrate, wherein the phosphor is deposited substantially only in one or more gaps between the electrodes.

17. The method according to claim 16, wherein the electrodes are opaque.

18. The method according to claim 16, wherein the step of forming electrodes is performed before the step of forming a phosphor.

19. The method according to claim 16, wherein the electrodes are formed by at least one of: screen printing, offset lithographic printing and etching.

20. The method according to claim 16, wherein the phosphor is formed by at least one of: screen printing and offset lithographic printing.

21. The method according to claim 16, wherein the phosphor comprises two or more different phosphors.

22. An electroluminescent device comprising:
a substrate;
one or more first electrodes on the substrate;
one or more second electrodes on the substrate;
one or more phosphor regions on the substrate, wherein the phosphor is in direct contact with the one or more first electrodes without an intervening dielectric layer.

23. The electroluminescent device according to claim 22, wherein the phosphor is in direct contact with the one or more second electrodes without an intervening dielectric layer.

24. The device according to claim 22, wherein the first and second electrodes are interdigitated.

25. The device according to claim 22, wherein the one or more first electrodes and the one or more second electrodes are opaque.

26. The device according to claim 22, wherein the phosphor comprises a binder comprising a mixture of a first and second constituent, the first constituent being one or more drying oils or semi drying oils or derivatives thereof and the second constituent being one or more sol-gel precursors.
